(19) United States
(12) Patent Application Publication
(10) Pub. No.: US 2025/0212073 A1
(43) Pub. Date: Jun. 26, 2025

(54) DATA FORWARDING FOR SEAMLESS ROAMING IN WIRELESS LOCAL AREA NETWORKS

(71) Applicant: Cisco Technology, Inc., San Jose, CA (US)

(72) Inventors: Binita Gupta, San Diego, CA (US); Brian Donald Hart, Sunnyvale, CA (US); Malcolm Muir Smith, Richardson, TX (US)

(21) Appl. No.: 18/990,109

(22) Filed: Dec. 20, 2024

Related U.S. Application Data
(60) Provisional application No. 63/612,702, filed on Dec. 20, 2023.

(51) Int. Cl. H04W 36/00; H04W 36/18; H04W 36/24

(52) U.S. Cl. CPC H04W 36/008357; H04W 36/18; H04W 36/249

(57) ABSTRACT

Disclosed are systems, apparatuses, processes, and computer-readable media for seamless roaming in networks. For example, an access point (AP) multi-link device (MLD) includes at least one memory and at least one processor coupled to the at least one memory. The processor is configured to: provide a data forwarding capability of the source AP MLD to a non-AP MLD; during roaming of the non-AP MLD to a target AP MLD, identify a first portion data in the source AP MLD to forward to the target AP MLD based on the data forwarding capability, wherein the target AP MLD and the source AP MLD are configured in a seamless mobility domain; and forward a first portion of data in the source AP MLD to the target AP MLD during roaming.

### CROSS-REFERENCE TO RELATED APPLICATIONS

This application claims priority to and the benefit of U.S. Prov. App. No. 63/612,515, filed on Dec. 20, 2023, the content of each of which is incorporated herein by reference in their entirety.

### TECHNICAL FIELD

The present disclosure relates to wireless local area networks and, in particular, data forwarding for seamless roaming in wireless local area networks based on selective data forwarding.

### BACKGROUND

Wi-Fi technology has undergone continuous evolution and innovation since its inception, resulting in significant advancements with each new generation. Following Wi-Fi 5 (802.11ac) there has been Wi-Fi 6 (802.11ax), Wi-Fi 7 (802.11be), and soon there will be Wi-Fi 8 (802.11bn) and Wi-Fi 9, each new Wi-Fi generation brings notable improvements in speed, capacity, efficiency, and overall performance.

Wi-Fi 5 introduced substantial upgrades over its predecessor, Wi-Fi 4 (802.11n). It introduced the use of wider channel bandwidths, multi-user Multiple-Input Multiple-Output (MIMO), and beamforming technologies. These advancements significantly increased data transfer rates and improved network capacity, allowing multiple devices to simultaneously connect and communicate more efficiently. Wi-Fi 6/6E included enhanced orthogonal frequency-division multiple access (OFDMA) and target wake time (TWT) mechanisms and included greater frequency and improved overall spectral efficiency and power management and better performance in crowded areas. Wi-Fi 7 (802.11be) delivers speeds of up to 30 Gbps, utilizing multi-band operation, wider bandwidth, advanced MIMO techniques, and improved modulation schemes. Wi-Fi 7 also focuses on reducing latency and enhancing security features.

Wi-Fi 8 (802.11bn) aims to revolutionize wireless connectivity by providing ultra-high reliability enabling rich experiences for QoS demanding applications such as cloud gaming, AR/VR, industrial IoT, wireless TSN etc. Wi-Fi 8 is expected to introduce advancements like seamless roaming, multi-AP coordination for predictable QoS, enhanced power saving and advanced beamforming techniques paving the way for futuristic applications and seamless connectivity experiences.

As Wi-Fi technology continues to evolve, each new Wi-Fi generation brings improvements that address the growing demands of modern networks, including increased device density, higher data rates, lower latency, improved reliability and better overall network performance. These advancements play a crucial role in enabling emerging technologies, supporting the proliferation of smart devices, and transforming the way we connect and communicate in an increasingly interconnected world.

### BRIEF DESCRIPTION OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 shows a pictorial diagram of an example wireless communication network according to some aspects of the present disclosure.

FIG. 2A illustrates an example of a wireless communication network spanning a single floor of a building according to some aspects of the present disclosure.

FIG. 2B depicts an illustrative schematic diagram for connectivity of an AP multi-link device (MLD) with multiple affiliated APs to a non-AP MLD with multiple affiliated non-AP STAs according to some aspects of the present disclosure.

FIG. 3 illustrates a conceptual diagram of a seamless roaming based on data forwarding in accordance with some aspects of the disclosure.

FIG. 4 illustrates a data structure illustrating a data forwarding capability information that can be exchanged in various manners in accordance with some aspects of the disclosure.

FIG. 5 is a conceptual diagram illustrating mapping information at a source AP MLD to be forwarded to a target AP MLD based on different technical capabilities in accordance with some aspects of the disclosure.

FIG. 6 is a conceptual flow diagram of an example process to determine data to be forwarded to a target AP based on data forwarding capability information in accordance with some aspects of the disclosure.

FIG. 7A is a sequence diagram illustrating roaming to a target AP MLD based on selective data forwarding capability in accordance with some aspects of the disclosure.

FIG. 7B is a sequence diagram illustrating roaming to a target AP MLD based on all data forwarding capability in accordance with some aspects of the disclosure.

FIG. 8 illustrates an example method of an AP MLD for implementing selective data forwarding based on data forwarding capability information in accordance with some aspects of the disclosure; and

FIG. 9 illustrates an example of a system for implementing certain aspects of the present technology.

### DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

A used herein the term “configured” shall be considered to interchangeably be used to refer to configured and configurable, unless the term “configurable” is explicitly used to distinguish from “configured”. The proper understanding of the term will be apparent to persons of ordinary skill in the art in the context in which the term is used.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Aspects of the present disclosure can be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), single-user (SU) multiple-input multiple-output (MIMO) and multi-user (MU) MIMO. The described implementations also can be implemented using other wireless communication protocols or RF signals suitable for use in one or more of a wireless personal area network (WPAN), a wireless local area network (WLAN), a wireless wide area network (WWAN), or an internet of things (IOT) network.

IEEE 802.11, commonly referred to as Wi-Fi, has been around for three decades and has become arguably one of the most popular wireless communication standards, with billions of devices supporting more than half of the worldwide wireless traffic. The increasing user demands in terms of throughput, capacity, latency, spectrum and power efficiency calls for updates or amendments to the standard to keep up with them. As such, Wi-Fi generally has a new amendment after every few years with its own characteristic features. In the earlier generations, the focus was primarily higher data rates, but with ever increasing density of devices, area efficiency has become a major concern for Wi-Fi networks. Due to this issue, the last (802.11 be (Wi-Fi 7)) amendments focused more on efficiency though higher data rates were also included. The next expected update to IEEE 802.11 is coined as Wi-Fi 8. Wi-Fi 8 will attempt to further enhance throughput and minimize latency to meet the ever growing demand for the Internet of Things (IoT), high resolution video streaming, low-latency wireless services, etc.

Multiple Access Point (AP) coordination and transmission in Wi-Fi refers to the management of multiple access points in a wireless network to avoid interference and ensure efficient communication between the client devices and the network. When multiple access points are deployed in a network—for instance in buildings and office complexes—they operate on the same radio frequency, which can cause interference and degrade the network performance. To mitigate this issue, access points can be configured to coordinate their transmissions and avoid overlapping channels.

Wi-Fi 7 introduced the concept of multi-link operation (MLO), which gives the devices (Access Points (APs) and Stations (STAs)) the capability to operate on multiple links (or even bands) at the same time. MLO introduces a new paradigm to multi-AP coordination which was not part of the earlier coordination approaches. MLO is considered in Wi-Fi-7 to improve the throughput of the network and address the latency issues by allowing devices to use multiple links.

A multi-link device (MLD) may have several “affiliated” devices, each affiliated device having a separate PHY interface, and the MLD having a single link to the Logical Link Control (LLC) layer. In IEEE 802.11be, a multi-link device (MLD) is defined as: “A device that is a logical entity and has more than one affiliated station (STA) and has a single medium access control (MAC) service access point (SAP) to logical link control (LLC), which includes one MAC data service” (see: LAN/MAN Standards Committee of the IEEE Computer Society, Amendment 8: Enhancements for extremely high throughput (EHT), IEEE P802.11 be™/D0.1, September 2020, section 3.2). Connection(s) with an MLD on the affiliated devices may occur independently or jointly. A preliminary definition and scope of a multi-link element is described in section 9.4.2.247b of aforementioned IEEE 802.11 be draft. An idea behind this information element/container is to provide a way for multi-link devices (MLDs) to share the capabilities of different links with each other and facilitate the discovery and association processes. However, this information element may still be changed or new mechanisms may be introduced to share the MLO information (e.g. related to backhaul usage).

In multi-link operation (MLO) both STA and APs can possess multiple links that can be simultaneously active. These links may or may not use the same bands/channels.

MLO allows sending PHY protocol data units (PPDUs) on more than one link between a STA and an AP. The links may be carried on different channels, which may be in different frequency bands. Based on the frequency band and/or channel separation and filter performance, there may be restrictions on the way the PPDUs are sent on each of the links.

MLO may include a basic transmission mode, an asynchronous transmission mode, and a synchronous transmission mode.

In a basic transmission mode, there may be multiple primary links, but a device may transmit PPDU on one link at a time. The link for transmission may be selected as follows. The device (such as an AP or a STA) may count down a random back off (RBO) on both links and select a link that wins the medium for transmission. The other link may be blocked by in-device interference. In basic transmission mode, aggregation gains may not be achieved.

In an asynchronous transmission mode, a device may count down the RBO on both links and perform PPDU transmission independently on each link. The asynchronous transmission mode may be used when the device can support simultaneous transmission and reception with bands that have sufficient frequency separation such as separation between the 2.4 GHz band and the 5 GHz band. The asynchronous transmission mode may provide both latency and aggregation gains.

In a synchronous PPDU transmission mode, the device may count down the RBO on both links. If a first link wins the medium, both links may transmit PPDUs at the same time. The transmission at the same time may minimize in-device interference and may provide both latency and aggregation gains.

Multi-AP coordination and MLO are two features proposed to improve the performance of Wi-Fi networks in the upcoming IEEE 802.11 be amendment. Multi-AP coordination is directed toward utilizing (distributed) coordination between different APs to reduce inter-Basic Service Set (BSS) interference for improved spectrum utilization in dense deployments. MLO, on the other hand, supports high data rates and low latency by leveraging flexible resource utilization offered by the use of multiple links for the same device.

Support for seamless/smooth roaming capability is a strong consideration for Wi-Fi8 to improve Wi-Fi roaming quality. To support smooth roaming/mobility in a campus wide Wi-Fi network, clients can create association with the campus-network/ESS instead of with an individual AP (MLD). The ESS might be represented by a mobility domain or, in the case that the network is a global network, then there can be multiple “sub-mobility domains” within a mobility domain, each of which can map to a single campus.

The client creates its association with the ESS network represented by a (sub) Mobility Domain MLD (Multi-Link Device), instead of associating with a single AP (MLD) within the ESS. Such an architecture will enable a client to roam seamlessly between AP MLDs without requiring (re) association and reestablishment of contexts with each new AP MLD, since the client associates with the Mobility Domain MLD covering all the AP MLDs of the ESS. Such an architecture can significantly reduce roaming time to realize seamless roaming.

In Wi-Fi7/11be, a non-AP MLD associates with an AP MLD as per the art. In Wi-FI8, a non-AP MLD is proposed to associate with an ESS/MDM and has link setup with one or more AP MLDs within that MDM. In some aspects, a non-AP MLD may need to roam from a target AP MLD to a source AP MLD based on network conditions. Roaming incurs delays based on the time involved with migrating network connections from the source to the target in a manner that ensures that the AP MLD receives all the packets. However, these delays create temporary disruptions in a network communication, such as a web conference which has low latency requirements.

Systems and techniques are described herein for enabling seamless roaming. According to aspects described herein, devices using seamless roaming can reduce interruptions during roaming between a source access point (AP) and a target AP. An example method includes providing, by a source AP, a data forwarding capability information of the source AP to a non-AP MLD device (e.g., a wireless STA); during roaming of the non-AP MLD device to a target AP, identifying a first portion data in the source AP to forward to the target AP based on the data forwarding capability information; and forwarding a first portion of data in the source AP to the target AP during roaming.

### Overview

In a wireless communication network, different generations (e.g., older and/or newer versions) of access points (APs) (or other network devices) may be utilized at the same time. In some examples, the different generations or versions of APs may have different capabilities. This may also apply to Wi-Fi generational capability. Aspects of the present disclosure are directed to incorporating and signaling “Generational Capabilities” of network devices (e.g., APs) among various devices operating in a wireless network to indicate performance capabilities of a particular device (e.g., what features may or may not be usable on a particular device). In the “Generational Capabilities” signaling, an optional sub-element or sub-field may be provided that includes a text string (e.g., can be a text string that is trademarked by the Wi-Fi Alliance (WFA) such as, for example, “Wi-Fi CERTIFIED™,” “Wi-Fi CERTIFIED Wi-Fi 7,” etc.) This approach is a simplified mechanism for signaling capabilities of Wi-Fi devices compared to, for example, cryptographic verification techniques, and is more privacy-preserving. Additionally, the present disclosure is directed to enabling associated APs on a wireless communication network to implement configurations based on the Generational Capabilities signaling received from other APs, including, but not limited to, modifying transmissions, communications, signals, etc., based on the Generational Capabilities signaling.

Systems and techniques are described herein for enabling seamless roaming. According to aspects described herein, devices using seamless roaming can reduce interruptions during roaming between a source access point (AP) multi-link device (MLD) and a target AP MLD. An example method includes providing, by a source access point (AP) multi-link device (MLD), a data forwarding capability of the source AP MLD to a non-AP MLD; during roaming of the non-AP MLD to a target AP MLD, identifying a first portion data in the source AP MLD to forward to the target AP MLD based on the data forwarding capability, wherein the target AP MLD and the source AP MLD are configured in a seamless mobility domain; and forwarding a first portion of data in the source AP MLD to the target AP MLD during roaming.

In one aspect, the data forwarding capability includes at least one of: a data forwarding support indicator indicating types of data forwarding supported by the source AP MLD; or a data forwarding policy identifying different types of data that can be forwarded by the source AP MLD. For example, the wherein the data forwarding support indicator indicates at least one of a selective data forwarding support, no data forwarding support, or AP selected data forwarding. In another example, the data forwarding policy includes at least one of a data flow selection indicator, a data forwarding type indicator, or an explicit indicator of whether negotiation for data forwarding parameters is supported with the non-AP MLD.

The data flow selection indicator comprises at least one of: a traffic identifier (TID) indicator for selecting data to forward based on TID; an access category (AC) indicator for selecting data to forward based on AC; or a stream classifier service identifier (SCS ID) indicator for selecting data to forward based on SCS ID. The data support forwarding type information indicator includes at least one of: a media access control (MAC) service data unit (MSDU) indicator for forwarding MSDUs or A-MSDUs; a MAC protocol data unit (MPDU) indicator for forwarding MPDUs that are not transmitted by the source AP MLD; or a transmitted MPDU indicator for forwarding MPDUs that have been transmitted by the source AP MLD to the non-AP MLD device.

In one example, the method includes an MLD negotiating data forwarding parameters with the non-AP MLD, and the negotiation of the data forwarding parameters is associated with a roaming request and a roaming response exchanged between the non-AP MLD and the source AP MLD. For example, the first portion of data is selected based on at least one of data selection indicator or data forwarding type indicator negotiated with the non-AP MLD.

In some aspects, the data forwarding capability is included in at least one of a beacon, probe response, association response, reassociation response, or a management frame.

In some aspects, the method may include receiving preference for data forwarding parameters from the non-AP MLD, wherein the first portion of data is selected based on data selection indicator.

In another aspect, the method may include transmitting, by the source AP MLD to the non-AP MLD, at least one of a starting sequence number (SN) of the first portion of data forwarded to the target AP MLD, or a last SN of buffered DL data that will be sent by the source AP MLD to the non-AP MLD. The method may also include transmitting the starting sequence number (SN) of the first portion of data or the last SN of the buffered DL data in a roaming response frame sent to the non-AP MLD.

In some aspects, the method includes negotiating data forwarding parameters with the non-AP MLD, wherein the first portion of data is selected based on at least one of data selection indicator or data support indicator negotiated with the non-AP MLD. The negotiation of the data forwarding parameters is associated with a roaming request and a roaming response exchanged between the non-AP MLD and the source AP MLD.

In some aspects, the data forwarding capability is included in at least one of a beacon, probe response, association response, reassociation response, a roaming related frame or a management frame.

In some aspects, the method includes receiving preference for data forwarding parameters from the non-AP MLD, wherein the first portion of data is selected based on data selection indicator.

In some aspects, the method includes providing the data forwarding capability for the source AP MLD or for the seamless mobility domain (SMD).

In some aspects, the source AP MLD transmits a second portion of data to the non-AP MLD device concurrently with forwarding the first portion of data to the target AP MLD.

In some aspects, the source AP MLD provides a buffered DL data transfer time to the non-AP MLD indicating a maximum time for which a second portion of data is available for transmitting to or fetch by the non-AP MLD.

In one aspect, the source AP MLD transmits a second portion of data to the non-AP MLD device concurrently with forwarding the first portion of data to the target AP MLD.

In one aspect, an AP MLD comprises one or more processors and a memory storing instructions that, when executed by the one or more processors, configure the AP MLD to provide a data forwarding capability information of the AP MLD to a non-AP MLD device. The AP MLD, during roaming of the non-AP MLD device to a target AP MLD, may identify a first portion data in the AP MLD to forward to the target AP MLD based on the data forwarding capability information. The AP MLD may forward a first portion of data in the AP MLD to the target AP MLD during roaming. The AP MLD may perform the method and operations further described with respect to the method and additional operations described herein.

In one aspect, a non-transitory computer-readable storage medium, the non-transitory computer-readable storage medium including instructions that when executed by a computer, cause the computer to provide a data forwarding capability information of the source AP MLD to a non-AP MLD device. The computer may, during roaming of the non-AP MLD device to a target AP MLD, identify a first portion data in the source AP MLD to forward to the target AP MLD based on the data forwarding capability information. The computer may forward a first portion of data in the source AP MLD to the target AP MLD during roaming. The computer may be integral to the source AP MLD and may perform the method and operations further described with respect to the method and additional operations described herein.

### Example Embodiments

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The disclosed technology addresses the need in the art for a way to signal Wi-Fi Generational Capabilities of devices in a network. As Wi-Fi technology develops, there still exists equipment that has not been upgraded to include new features incorporated in new Wi-Fi rollouts and developments (e.g., Wi-Fi 7). However, older equipment is still necessary to functionality in a Wi-Fi network and in communications between user devices. There currently exists a proposition to incorporate a “Generational Capabilities” signaling between devices to indicate performance capabilities of a particular device (e.g., what features may or may not be usable on a particular device). This may indicate a highest version of Wi-Fi that is supported. However, there exists a need to enforce false claiming (e.g., a device that claims that it supports Wi-Fi 7 when it only supports up to Wi-Fi 5) and how a receiving device may adapt transmissions to accommodate an older device with limited capabilities.

In the “Generational Capabilities” signaling, an optional sub-element or sub-field that includes a text string can be included. In some non-limiting examples, the text string may be a trademarked phrase (e.g., by Wi-Fi Alliance (WFA)) including, but not limited to, “Wi-Fi CERTIFIED™,” “Wi-Fi CERTIFIED Wi-Fi 7,” etc. Unlike asserting a Boolean or integer capability which cannot be trademarked, WFA can license the use of this mark (text string) and has legal recourse against vendors that advertise it outside the allowed use of the mark, which then makes it desirable to signal. This may make it an easier path than cryptographic verification of certification, and more privacy-preserving. The element may contain a single string that is a prerequisite for claiming any support for Wi-Fi generations, or specifically claims certification of the highest (or only) generation claimed, or of each generation claimed. Devices that are not certified may use an alternate string that may have the same length as the certified string for ease of signaling. These strings can be sent at or after association for greater protection/privacy.

A user device (and/or an access point) may apply different configurations depending on the capabilities of an associated device. For example, certain features, speeds, messaging, transmissions, etc. may be modified to accommodate an older device. A user device may refuse to connect to an AP unless it has certain Generational Capabilities. In some examples, associated devices may verify the Generational Capabilities signaling through one or more tests, and if the tests demonstrate that the signaling is inconsistent with the capabilities of the device, then the device may be flagged as a rogue AP/device.

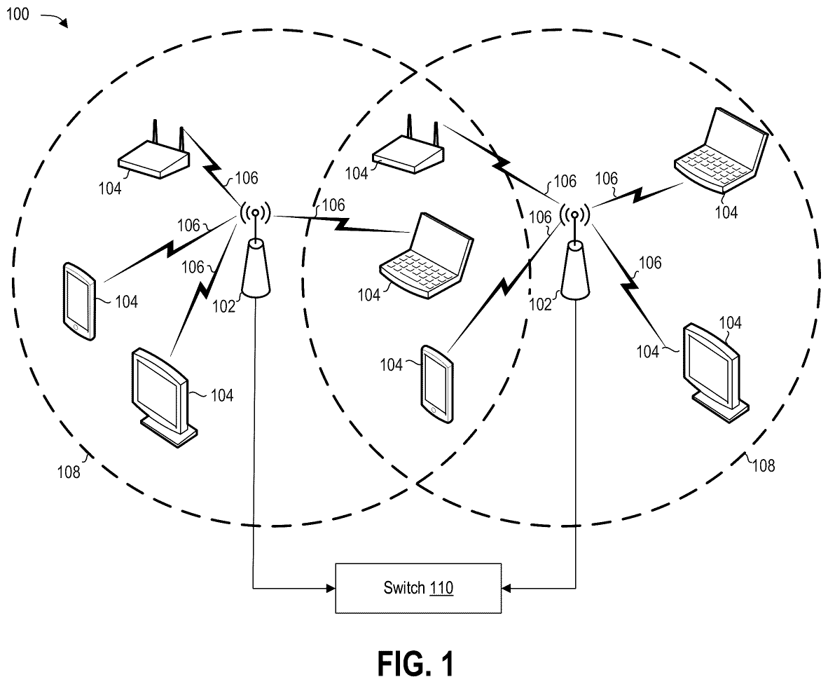

FIG. 1 illustrates a block diagram of an example wireless communication network 100. According to some aspects, the wireless communication network 100 may be an example of a wireless local area network (WLAN) such as a Wi-Fi network. For example, the wireless communication network 100 may be a network implementing at least one of the IEEE 802.11 family of wireless communication protocol standards and amendments thereof (such as that defined by the IEEE 802.11-2016 specification or amendments thereof including, but not limited to, 802.11ay, 802.11ax, 802.11az, 802.11ba and 802.11be). Additionally, the wireless communication network 100 may implement future versions and amendments of the wireless communication protocol standards and amendments thereof such as 802.11bn and be modified according to the present disclosure to include the features contained herein. The wireless communication network 100 may include numerous wireless communication devices such as an AP actor, which can be one or more of a non-MLD AP, an AP affiliated with an AP MLD, and/or an AP MLD. In the examples presented herein, the AP actor can exclude an upper UMAC. Therefore, the AP actor can include the lower UMAC, LMAC, and/or PHY. Additionally, the WLAN can include one or more of STA actors 104, which can be one or more of a non-MLD STA, a STA affiliated with a non-AP MLD, and/or a non-AP MLD. As illustrated, the wireless communication network 100 also may include multiple AP actors such as AP actors 102 (may also be referred to as simply AP). The AP actors 102 can be coupled to one another through a switch 110. While the AP actors 102 are shown as being coupled to one another through a switch 110, the network can provide another device that allows the coupling of the multiple AP actors.

Each of the STA actors 104 also may be referred to as a mobile station (MS), a mobile device, a mobile handset, a wireless handset, an access terminal (AT), a user equipment (UE), a subscriber station (SS), client, or a subscriber unit, among other examples. The STA actors 104 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other examples. In other examples, the STA actors 104 can be referred to as clients and/or client devices.

Any one of the AP actors 102 and an associated set of STA actors 104 may be referred to as a basic service set (BSS), which is managed by a respective AP actor of AP actors 102. FIG. 1 additionally shows an example coverage areas 108 of the each of the AP actors 102, which may represent a basic service area (BSA) of the wireless communication network 100. As illustrated, three of the STA actors 104 are within the BSA of each of the AP actors 102. The BSS may be identified to users by a service set identifier (SSID), where the BSS might be one of many in the SSID. The BSS may be identified to other devices by a unique (or substantially unique) basic service set identifier (BSSID). One or more of the AP actors 102 periodically broadcasts beacon frames (“beacons”) including the BSSID to enable STA actors 104 within wireless range of the AP actors 102 to “associate” or re-associate with the AP actors 102 to establish a respective communication link of communication links 106 (hereinafter also referred to as a “Wi-Fi link”), or to maintain the communication links 106, with the AP actors 102. For example, the beacons may include an identification of a primary channel used by the respective AP actor of AP actors 102 as well as a timing synchronization function for establishing or maintaining timing synchronization with the AP actors 102. The AP actors 102 may provide communication links 106 to the STA actors 104 and therefore access to external networks. While the example has been described in regards to the AP actors 102 and STA actors 104, the present disclosure extends such that an AP actor may provide access to external networks to various STA actors in a WLAN via the communication links 106.

To establish the communication links 106 with any one of the AP actors 102, each of the STA actors 104 is configured to perform passive or active scanning operations (“scans”) on frequency channels in one or more frequency bands (for example, the 2.4 GHz, 5 GHz, 6 GHz or 60 GHz bands). To perform passive scanning, the STA actors 104 listen for beacons, which are transmitted by a respective AP actor of AP actors 102 at or near a periodic time referred to as the target beacon transmission time (TBTT) (measured in time units (TUs) where one TU may be equal to 1024 microseconds (μs)). To perform active scanning, the STA actors 104 generate and sequentially transmits probe requests on each channel to be scanned and listens for probe responses from AP actors 102. The STA actors 104 may be configured to identify or select an AP and thence a selected AP actor of AP actors 102 with which to associate based on the scanning information obtained through the passive or active scans, and to perform authentication and association operations to establish the communication links 106 with the selected AP actor of AP actors 102. The selected AP actor of AP actors 102 assigns an association identifier (AID) to the STA actors 104 at the culmination of the association operations, which the selected AP actor of AP actors 102 uses to improve the efficiency of certain signaling to the STA actors 104.

The present disclosure modified the WLAN radio and baseband protocols for the PHY and medium access controller (MAC) layers. The AP actors 102 and STA actors 104 transmit and receive wireless communications (hereinafter also referred to as “Wi-Fi communications”) to and from one another in the form of PHY protocol data units (PPDUs). The AP actors 102 and STA actors 104 also may be configured to communicate over other frequency bands such as shared licensed frequency bands, where multiple operators may have a license to operate in the same or overlapping frequency band or bands.

Each PPDU is a composite structure that includes a PHY preamble and a payload in the form of one or more PHY service data unit (PSDU). The information provided in the preamble may be used by a receiving device to decode the subsequent data in an intended PSDU. In instances in which PPDUs are transmitted over a bonded channel, selected preamble fields may be duplicated and transmitted in each of the multiple component channels.

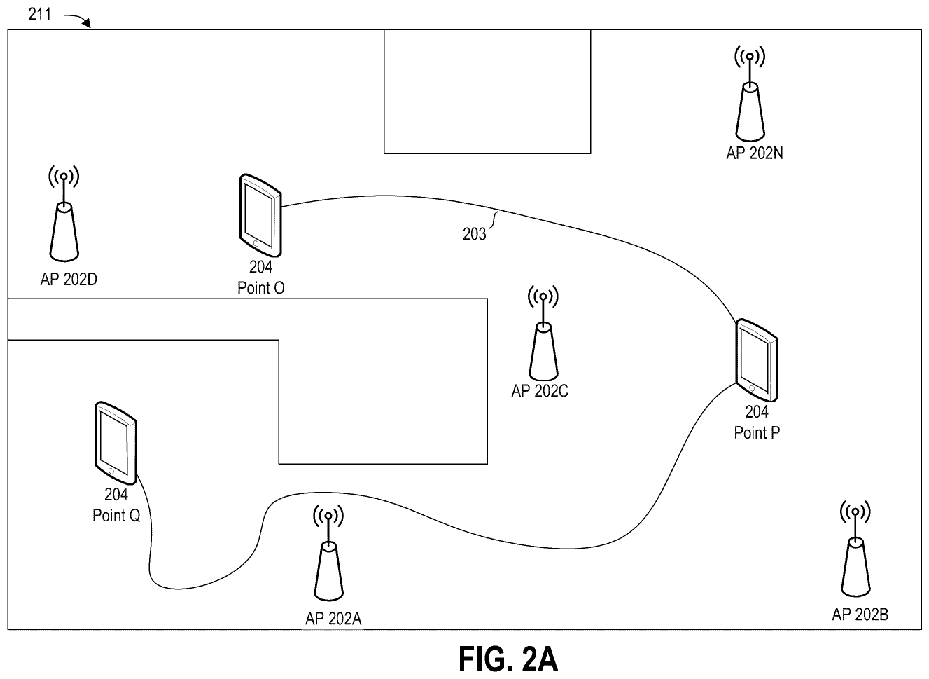

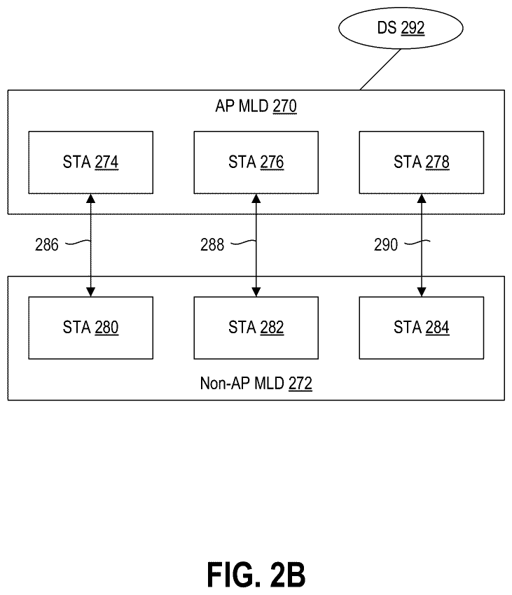

FIG. 2A illustrates an example a single floor 211 of building. While only a single floor is illustrated a description equally applies to multiple floors in a building. Additionally, some of the floors in a building may not be contiguous, such that floors 1, 3, 4, and 8 span a network for a building that has floors 1-10. Thus, in at least one implementation the building can include one or more floors that do not have a network including one or more AP actors. As illustrated, the single floor 211 includes AP actors 202A, 202B, 202C, 202D, 202N. Each of the AP actors 202A, 202B, 202C, 202D, 202N can have a respective coverage area such that an overall coverage area can span substantially the entire floor. In other examples, the overall coverage area can extend beyond the entire floor. In other examples, the overall coverage area can extend beyond the entire floor. Additionally, the coverage of an AP actor of AP actors 202A, 202B, 202C, 202D, 202N may substantially overlap with the coverage of another AP actor of the AP actors 202A, 202B, 202C, 202D, 202N.

As illustrated by the line 203, STA actor 204 can move from point O to point P to point Q. When a STA actor 204 is moving around on a given floor, one or more of the AP actors 202A, 202B, 202C, 202D, 202N can be considered to be nearest to the STA actor 204. Nearest as used in relation to the AP actors 202A, 202B, 202C, 202D, 202N and STA actor 204 can include being physically nearest (for example, a Euclidean distance on the floor) and/or pathloss-nearest (for example, having the lowest wireless attenuation (pathloss) between AP actor, among all the AP actors, and STA actor). Additionally, the pathloss-nearest approach can be used to reduce the likelihood of connection between an AP actor on a floor above or below the STA actor 204. The location of the AP actor on the floor above or below might be closer in a Euclidean sense, but also not be a desirable AP for the connection of the device or station due to the floor location and/or possible signal interruption. The location of the AP actor on the floor above or below might be closer in a straight line and/or Euclidean sense, but also not be a desirable AP for the connection of the device or station due to the floor location and/or possible signal interruption. Additionally, the coverage of one or more AP actors can at least partially overlap with the coverage of one or more other AP actors. The present disclosure provides for selecting the AP actor and/or providing a communication pathway from one or more STA actors through one or more AP actors.

FIG. 2B depicts an illustrative schematic diagram for MLO between an AP MLD with affiliated logical entities and a non-AP MLD with affiliated logical entities according to some aspects of the present disclosure.

Referring to FIG. 2B, two multi-link logical entities AP MLD 270 and Non-AP MLD 272 are shown. AP MLD 270 may include physical and/or logical affiliated AP 274, AP 276, and AP 278 operating in different channels and typically different frequency bands (e.g., 2.4 GHz, 5 GHz, and 6 GHz). AP 274, AP 276, and AP 278 may be the same as or similar to any one of the APs described above. Non-AP MLD 272 may include STA 280, STA 282, and STA 284, which may be the same as or similar to any of the STAs as described herein.

AP 274 may communicate with STA 280 via link 286. AP 276 may communicate with STA 282 via link 288. AP 278 may communicate with STA 284 via link 290.

AP MLD 270 is shown in FIG. 2B to have access to a distribution system (DS) 292, which is a system used to interconnect a set of BSSs to create an extended service set (ESS).

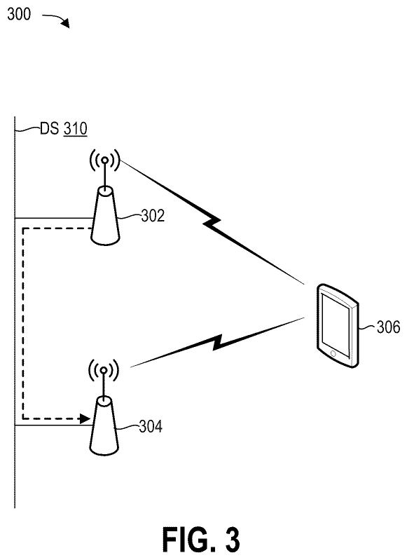

It should be understood that although the example shows three logical entities within the AP MLD and the three logical entities within the non-AP MLD, this is merely for illustration purposes and that other numbers of logical entities within each of the AP MLD and non-AP MLD may be envisioned. The example Wi-Fi systems and MLO described above with reference to FIGS. 1 and 2A-B provide examples of simplified and example systems of the present disclosure. Additional details of the present disclosure are provided in relation to FIGS. 3, 4, 5, 6, 7A, 7B, 8, and 9.

FIG. 3 illustrates a conceptual diagram 300 of a seamless roaming based on data forwarding in accordance with some aspects of the disclosure. In some aspects, a source AP MLD 302 and a target AP MLD 304 may support data forwarding during roaming to minimize gaps in data transmission as a non-AP MLD 306 (e.g., a laptop, a cellular phone, a virtual reality (VR) headset, etc.) roams between the source AP MLD 302 to the target AP MLD 304. The non-AP MLD 306 may be a client device such as a laptop, a cellular phone, a virtual reality (VR) headset, etc.

In some aspects, the source AP MLD 302 is configured to transfer control plane context (e.g., state information) and selective data packets for certain identified slows to the target AP MLD 304. There are different mechanisms for identifying the types of packets, such as based on specific traffic identifiers (TIDs), one or more access categories (ACs), or one or more stream classifier service (SCS) streams.

In some aspects, the source AP MLD 302 and the target AP MLD 304 may be connected by a distribution system (DS) 310 and the source AP MLD 302 may select packets to forward to the target AP MLD 304 to minimize network effects such as latency and jitter during the roaming. For example, the source AP MLD 302 may forward a portion of packets to the target AP MLD 304 during the roaming operation.

In some aspects, different types of packets can be forwarded to the target AP 3 MLD 04 based on the state of the packet within the source AP MLD 302. For example, a MAC service data unit (MSDU) can be forwarded because it has not been processed by the source AP MLD 302 and is generally stored in volatile memory (e.g., double data rate (DDR) memory). As an example, the MSDUs have not been assigned a sequence number. MAC protocol data units (MPDUs) may be forwarded to the target AP MLD 304 based on the capability of the source AP MLD 302 and the target AP MLD 304. MPDUs have been processed within a software layer by the processor and are assigned a sequence number (SN). In this case, the MPDUs may have been transmitted already, and forwarding an earlier transmitted MPDU can lead to duplication and synchronization issues at the target AP MLD 304. In some cases, MPDUs that have not been transmitted.

In other examples, the source AP MLD 302 and the target AP MLD 304 may be part of a seamless mobility domain (SMD) and the source AP MLD 302 may encrypt packets based on a controller (not shown). In this case, the source AP MLD 302 may be able to forward MPDUs because the SN and the packet number (PN), which are assigned prior to encryption, can be mapped between the source AP MLD 302 and the target AP MLD 304 based on information shared within the SMD.

In this way, the source AP MLD 302 can transmit some packets associated with a particular application (e.g., video conferencing) over the air and concurrently forward some packets of that same application using the DS 310 to minimize any delays.

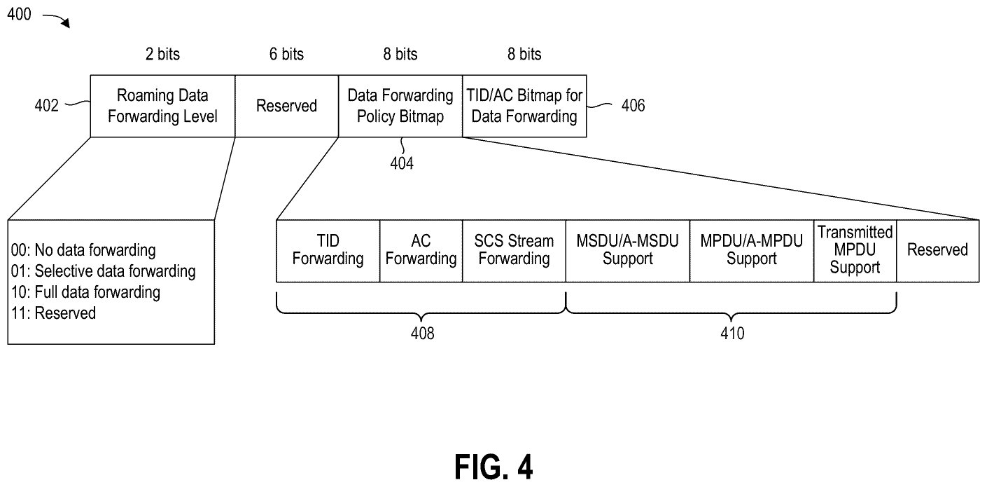

FIG. 4 illustrates a data structure 400 illustrating a data forwarding capability information that can be exchanged in various manners in accordance with some aspects of the disclosure. In some cases, an AP MLD announces data forwarding capability for the type of data forwarding. Non-limiting examples of include transmitting the data forwarding capability information in a beacon, a probe response, and management frames related to roaming.

The data structure 400 includes roaming data forwarding level 402 that identifies the level of support, with “00” indicating no support for seamless roaming. In this case, the non-AP MLD must retrieve downlink data from the source MLD during roaming to ensure seamless handover. A roaming data forwarding level 402 with a value “01” indicates selective data forwarding, which indicates the AP MLD forwards selective data packets for certain types of traffic to the AP MLD during roaming. Selective data forwarding can be supported based on various criteria such as based on TID, AC, or SCS stream. In some aspects, the data forwarding policy for selective data forwarding may be negotiated between the AP MLD and the non-AP MLD during the roaming procedure. For example, the AP MLD may have a policy to forward data for high QoS traffic such as TIDs 4 to 7. A roaming data forwarding level 402 with a value of “10” indicates the AP MLD supports forwarding all buffered data packets to the AP MLD during roaming.

The data structure 400 also includes a data forwarding policy bitmap 404 that identifies the type of forwarding the AP MLD supports. For example, the data forwarding policy bitmap 404 may be a map of bits indicating a selection information 406 and type information 408. The selection information 406 identifies a classification associated with the traffic such as for QoS or prioritization techniques. For example, the selection information may include bits to indicate support for TID-based forwarding, AC-based forwarding, and SCS stream-based forwarding. The type information 408 indicates a type of data that the AP MLD supports. Non-limiting examples of the type information 408 includes A-MSDU/MSDU support, MPDU support, and transmitted MPDU support. The type information 408 identifies where the data may be located and the selection information 406 may be used to filter data. For example, MSDUs have not been processed and are stored in volatile memory and MPDUs have been processed and may be stored in a transmission buffer or cache. In some aspects, 2 bits in the data forwarding policy bitmap 404 are reserved.

In some cases, the data structure 400 may also include an optional TID/AC bitmap 410 that identifies various TID or AC values supported by the AP MLD. The TID/AC bitmap 410, in conjunction with the selection information 406, are used to select supported data that can be forwarded. The TID/AC bitmap 410 and the selection information 406 may also be used in connection with a negotiation between the source AP MLD and the non-AP MLD to determine relevant flows and other traffic to forward. For example, if the non-AP MLD is actively connected with a video conference, the non-AP MLD's state may prioritize specific TIDs relevant to its current state.

In some aspects, the data structure 400 may be an integrated into an information element (IE), for example in a reserved field. In other aspects, the data structure 400 may also be defined as a separate IE. In some cases, the data structure 400 may also be used in different types of reporting, such as the reduced neighbor report (RNR).

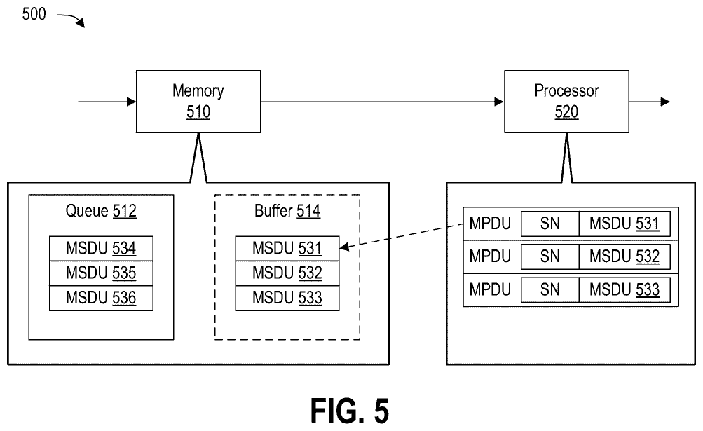

FIG. 5 is a conceptual diagram 500 illustrating mapping information at a source AP MLD to be forwarded to a target AP MLD based on different technical capabilities in accordance with some aspects of the disclosure. In particular, FIG. 5 illustrates different variations of a source AP MLD and its ability to forward MSDUs based on different techniques based on unencrypted states. In some aspects, an SN and a PN may added before encryption. In some aspects, forwarding packets to a different device after the packets have received a SN (or PN) is challenging because the sequence number is part of a stream-specific order and ensures data integrity and correct reassembly. Changing the destination midstream disrupts the sequence context and may cause out-of-order delivery or loss of synchronization. A received device or application is expecting a continuous and ordered flow, and synthesizing the sequence of a single stream for two different data streams is not practical. In addition, SNs are often tied into reliability mechanisms such as acknowledgments or non-acknowledgments, and rerouting packets after assigning a SN (or PN) can complicate or break reliability processes.

In some aspects, the source AP MLD includes a memory 510 (e.g., DDR memory) for storing buffered content before processing. For example, a receiver and corresponding demodulator (not shown) output MSDUs into a queue 512, which is a first-in first-out data structure. The queue 512 is an example for illustrative purposes and the details of the storage from the receiver can vary. The queue 512 is configured to store MSDUs in an order in which they are received, with MSDU 534, MSDU 535, and MSDU 536 being stored and unprocessed by the processor 520. In this case, each of the MSDU 534, MSDU 535, and MSDU 536 do not have an SN or a PN and can easily be forwarded to a target AP MLD (not shown). In this aspect, MSDUs within the memory 510 can be forwarded without any significant processing modification of the source AP MLD because a SN has not been assigned. The source AP MLD can gracefully forward the MSDU 534, MSDU 535, and MSDU 536 to a target AP MLD for seamless roaming.

In another aspect, MSDUs can be aggregated into an aggregated-MSDU (A-MSDU), which encapsulates a plurality of MSDUs. In the case of A-MSDUs, the source AP MLD may disaggregate the A-MSDUs into individual MSDUs and forward the MSDUs to the target AP MLD for seamless roaming.

In another aspect, the processor 520 may have processed and encapsulated the earlier MSDUs. For example, MSDU 531, MSDU 532, and MSDU 533 were previously processed and are assigned SNs in connection with transmission acknowledgments. In some cases, the target AP MLD can be configured to forward MSDUs from the MPDUs after encapsulation, but before transmission. The more processing that has occurred to the MSDU, the more complex the process of forwarding the MPDUs becomes. In one aspect, a technique to forward the MSDUs in MPDUs is by creating an optional buffer 514 storing copies of the MSDU 531, MSDU 532, and MSDU 533, and creating a pointer that links the SN of the MPDU to the memory address of the corresponding MPDU. In this case, the processor 520 would be able to forward copies of the MSDU 531, MSDU 532, and MSDU 533 in the buffer while dropping the corresponding MPDUs. The processor 520 may also need to update its state to not include the SNs of the MSDU 531, MSDU 532, and MSDU 533. Other techniques are also possible and may require coordination between the source AP MLD and the target AP MLD. This aspect may also be implemented in A-MPDUs as well, with several pointers for an individual A-MPDU to refer to copies of the individual MSDUs in the buffer 514.

In another aspect, the source AP MLD and the target AP MLD may be configured to forward MPDUs that have been transmitted but have not been acknowledged or non-acknowledged. In this case, the source AP MLD and the target AP MLD may need to negotiate and coordinate the order of the SNs at both the source AP MLD and the target AP MLD. In the case of transmitted MPDU support, the source AP MLD may transmit a sequence number to the

[symbol]

In another aspect, the source AP MLD may operate in a different manner based on whether encrypted data is transmitted. For example, during the generation of an encrypted MPDU, an SN may be assigned and encrypted, and a packet number may be generated for the MPDU header. In this case, the source AP MLD may forward the SN and PN to the target AP MLD, which in turn generates and transmits frames with the corresponding SN and PN to maintain order at the non-AP MLD device. In this case, the non-AP MLD device may successfully synthesize data from two different sources and perform any deduplication based on a continuation SN and PN.

In some aspects, when the target AP MLD indicates MPDU reception capability, the source AP MLD may default to opt-in to MPDU forwarding unless there are explicit instructions to deny MPDU forwarding.

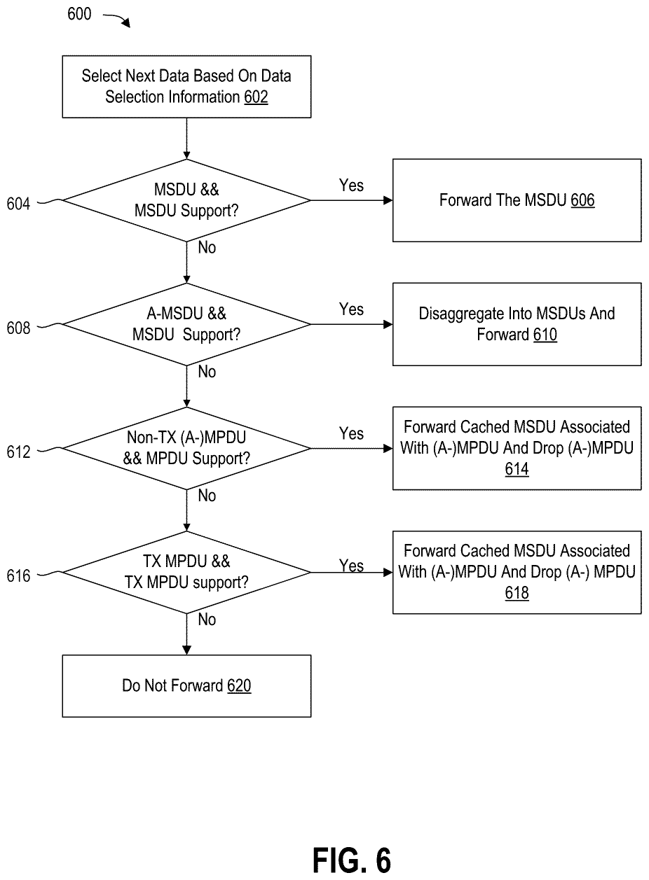

FIG. 6 is a conceptual flow diagram of an example process 600 to determine data to be forwarded to a target AP MLD based on data forwarding capability information in accordance with some aspects of the disclosure. In some aspects, the process 600 illustrates how a packet is selected based on high level overview. The implementation in code may be significantly different because the process 600 may selects a data source (e.g., volatile memory, etc.) and then filter the data source based on the classification (e.g., TID, AC, SCS, etc.).

At block 602, an AP MLD may select the next data based on the data selection information. For example, the data selection information may filter based on TID, AC, and SCS to remove all data that does not comport with the data forwarding policies.

At block 604, the AP MLD determines if the data is an MSDU and the AP MLD support MSDU forwarding. If the data is an MSDU and MSDU forwarding is supported, the AP MLD forwards the MSDU (e.g., to a target AP MLD) at block 606. If the data is not an MSDU or MSDU forwarding is not supported, the process moves to block 608.

At block 608, the AP MLD determines if the data is an MSDU and the AP MLD supports MSDU forwarding. If the data is an A-MSDU and MSDU forwarding is supported, the AP MLD disaggregate the A-MSDU into individual MSDUs and forwards the MSDU (e.g., to a target AP MLD) at block 610. If the data is not an A-MSDU or MSDU forwarding is not supported, the process moves to block 612.

At block 612, the AP MLD determines if the data is a non-transmitted MPDU and the AP MLD supports MPDU forwarding. If the data is a non-transmitted MPDU and MPDU forwarding is supported, the AP MLD forwards the data in the MPDU. In one aspect, at block 614, the AP MLD may forward a cached copy of the MSDU associated with the MPDU and drop the MPDU. In some aspects, the data may also be a non-transmitted A-MPDU which maps to multiple corresponding cached MSDUs, which would be forwarded while the A-MPDU is dropped. In other examples, the AP MLD may decode the MPDU and forward data within the MPDU. If the data is not a non-transmitted MPDU or MPDU forwarding is not supported, the process moves to block 616.

At block 616, the AP MLD determines if the data is a transmitted MPDU (or transmitted A-MPDU) and the AP MLD supports transmitted MPDU forwarding. If the data is a transmitted MPDU and MPDU forwarding is supported, the AP MLD forwards data within the transmitted MPDU. For example, the AP MLD may forward cached copies of the corresponding MSDU at block 618. If the data is not a transmitted MPDU or MPDU forwarding is not supported, the process moves to block 620. At block 620, the data is not forwarded.

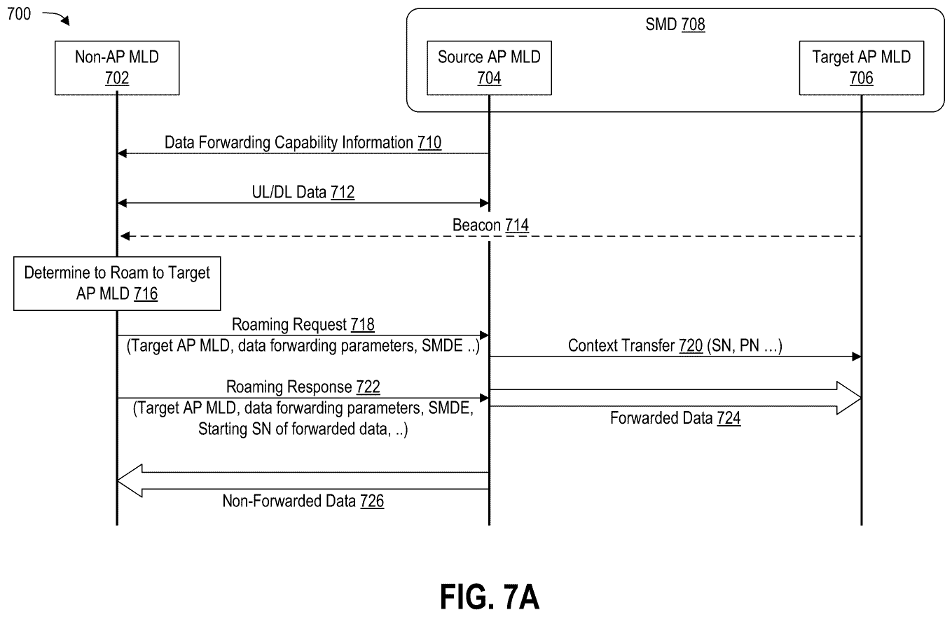

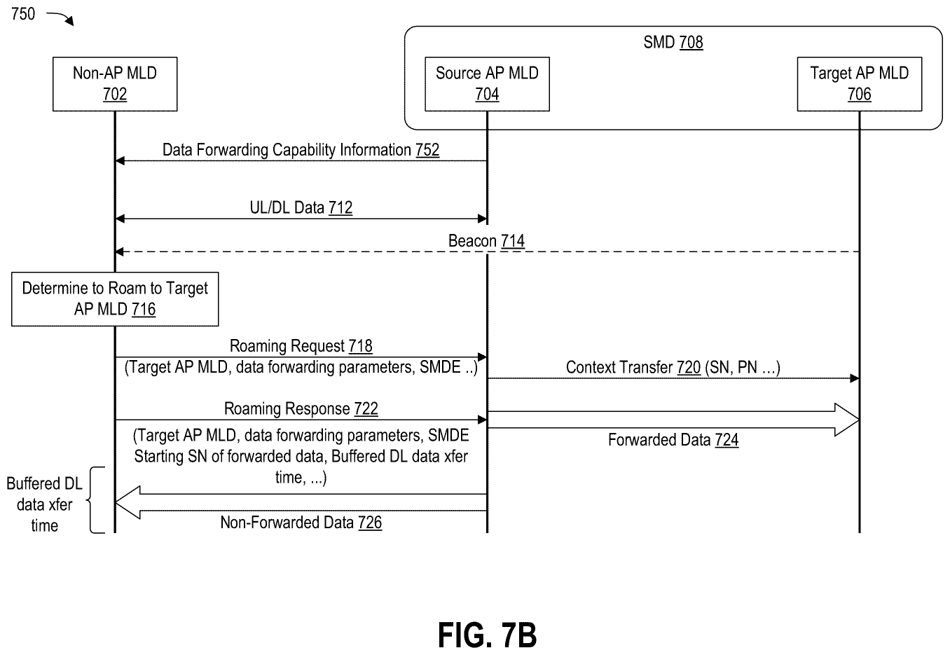

FIG. 7A is a sequence diagram illustrating roaming to a target AP MLD based on selective data forwarding capability in accordance with some aspects of the disclosure. In some aspects, a communication system 700 includes a non-AP MLD 702, a source AP MLD 704 that initially forms a connection with the non-AP MLD 702 and a target AP MLD 706 that the non-AP MLD 702 will roam to. The source AP MLD 704 and the target AP MLD 706 are part of an SMD 708.

In some aspects, the source AP MLD 704 may provide data forwarding capability information 710 (e.g., the data structure 400 in FIG. 4) to the non-AP MLD 702. In some aspects, the data forwarding capability information 710 can be included in a beacon, a probe response, association response, reassociation response, or part of in connection with individually addressed (e.g., to the non-AP MLD 702) management frames related to roaming or another management frame. In the example illustrated in FIG. 7A, the data forwarding capability information 710 includes a selective data roaming value that forwards some data based on a negotiation and/or based on determination made by the source AP MLD.

After the data forwarding capability information 710 is received, the non-AP MLD 702 may communicate (e.g., transmit and receive) uplink (UL) and downlink (DL) data 712 with the source AP MLD 704. In one aspect, the non-AP MLD 702 may be mobile and may receive a beacon 714 from the target AP MLD 706. At block 716, the non-AP MLD 702 may determine to roam from the source AP MLD 704 to the target AP MLD 706 based on the quality of the signals from the source AP MLD 704 and the target AP MLD 706. For example, the non-AP MLD 702 may be participating in a video conference that requires low latency data, and the target AP MLD 706 may be on a channel with more capacity and with a better RSSI.

As noted above, the data forwarding capability information 710 includes a selective data forwarding value that forwards some data from the source AP MLD 704 to the target AP MLD 706 during roaming based on a negotiation and/or determination by the source AP MLD. In one aspect, the data can be forwarded based on at least one of the data forwarding policy of the source AP MLD (e.g. based on data forwarding policy bitmap 404 and the TID/AC bitmap 410), the capability of the target AP MLD to receive forwarded data, or the negotiation performed between the source AP MLD and the non-AP MLD for data forwarding. In this case, the non-AP MLD 702 and the source AP MLD 704 may negotiate data forwarding based on the state of each device by exchanging negotiation information for negotiating data forwarding parameters as part of signaling exchange. For example, the non-AP MLD 702 can be actively partaking in a video conference and may request only very high TID levels corresponding to the best QoS.

In one aspect, the negotiation for data forwarding is performed as part of roaming request/response management frames that are used to perform roaming. For example, the non-AP MLD 702 may send a roaming request 718 with roaming information such as the identity of the target AP MLD 706, data forwarding parameters, SMDE, and so forth. The source AP MLD 704 provides a roaming response 722 that indicates the negotiated data forwarding parameters. In some aspects, the roaming response can also indicate the starting SN of the forwarded data to the non-AP MLD to allow the non-AP MLD 702 to determine when it has received all the remaining buffered DL data from the source AP MLD 704. For example, this data will have SN smaller than the starting SN of the forwarded data and the non-AP MLD 702 can then transition to receiving data from the target AP MLD 706. In another aspect, the roaming response 722 can also indicate the last SN of the buffered DL data that will be sent by the source AP MLD 704 to the non-AP MLD 702. The last SN of buffered DL data can be used by the non-AP MLD 702 to determine when it has received all the remaining buffered DL data from the source AP MLD 704, and it can then transition to receiving data from the target AP MLD 706.

In some aspects, the source AP MLD 704 may also send a context transfer 720 to the target AP MLD 706 providing context related to data for the Non-AP MLD 702. In one example such context can include Sequence Number and Packet Number associated with the data for Non-AP MLD. In one example, the data forwarding parameters may result in data selection information for selecting traffic based on a classification (e.g., TID, AC, SCS, etc.) and type information for selecting data at different states within the source AP MLD 704 (e.g., unprocessed MSDU, non-transmitted MPDU, transmitted MPDU, etc.). The data forwarding parameters are the parameters selected/negotiated based on the data capability information and are implemented in the source AP MLD 704 to select data to forward data while a non-AP MLD is roaming.

In one example, the SN may be required to be sent to the target AP MLD for the data being forwarded when the source AP MLD 704 supports forwarding MPDUs to the target AP MLD 706 that were previously transmitted by the source AP MLD 704 to the Non-AP MLD 702, and may also be transmitted over the DS (e.g., the DS 310 in FIG. 3) to the target AP MLD 706.

The source AP MLD 704 is configured to forward the data (e.g., forwarded data 724 that may be unencrypted or encrypted) identified to the target AP MLD 706 over the DS. In this case, the source AP MLD 704 may take necessary steps to pause transmitting or retransmitting this data to the Non-AP MLD 702, while continuing to transmit the non-forwarded data 726 (e.g., the data not selected for forwarding) to the non-AP MLD 702. For example, the non-forwarded data 726 may not comport with the data classification (e.g., unsupported TID or AC, etc.) and may include rest of the data that was not forwarded to the target AP MLD.

Upon reception of the forwarded data 724, the target AP MLD 706 is configured to transmit the forwarded data 724 to the non-AP MLD over-the-air. In this case, the target AP MLD 706 may receive the forwarded data 724 as MSDUs, process the MSDUs into MPDUs, and transmit the MPDUs to the non-AP MLD 702. In this case, the non-AP MLD 702 may concurrently receive the forwarded data 724 from the target AP MLD 706 and the non-forwarded data 726 from the source AP MLD 704. In some cases, the forwarded data 724 may be slightly delayed from the target AP MLD 706, but the time delay is minimized based on data forwarding of some data (selective data forwarding) during the roaming.

FIG. 7B is a sequence diagram illustrating roaming to a target AP MLD based on all data forwarding capability in accordance with some aspects of the disclosure. In some aspects, a communication system 750 includes a non-AP MLD 702 that initially forms a connection with the source AP MLD 704, and a target AP MLD 706 that the non-AP MLD 702 will roam to.

In some aspects, data forwarding capability information 752 (e.g., the data structure 400 in FIG. 4) may be provided to the non-AP MLD 702. In the example illustrated in FIG. 7B, the data forwarding capability information 752 includes a value indicating forwarding of all data. In some aspects, all data is not forwarded due to data selection information (e.g., specific data classifications), as further described below.

After the data forwarding capability information 752 is received, the non-AP MLD 702 may communicate (e.g., transmit and receive) data 712 with the source AP MLD 704. In one aspect, the non-AP MLD 702 may be mobile and may receive a beacon 714 from the target AP MLD 706. At block 716, the non-AP MLD 702 may determine to roam from the source AP MLD 704 to the target AP MLD 706 based on the quality of the signals from the source AP MLD 704 and the target AP MLD 706. For example, the non-AP MLD 702 may be participating in a video conference that requires low latency data, and the target AP MLD 706 may be on a channel with lower latency or higher bandwidth.

The non-AP MLD 702 notifies the source AP MLD 704 of an intent to roam to the target AP MLD 706 which includes data forwarding parameters (for selecting data to be forwarded to target AP MLD) n in a roaming request 718. In some aspects, the roaming request may select different data classifications based on a state of the non-AP MLD 702. For example, in the event the non-AP MLD 702 has high QoS requirements (e.g., during a VR application), the non-AP MLD 702 may explicitly identify specific data classifications to prioritize data that is forwarded to the target AP MLD 706. In one case, the source AP MLD may accept the data classifications from the non-AP MLD 702 received in the data forwarding parameters in 718. In another case, the source AP MLD may select a modified data classifications than what was proposed by the Non-AP MLD in 718 and indicate its selection in the data forwarding parameters sent to the non-AP MLD in 722. In this case, there is negotiation of data forwarding parameters between the Non-AP MLD 702 and the source AP MLD 704.

After the receiving the roaming request 718, the source AP MLD 704 identifies data in (or expected) by the non-AP MLD 702 to forward to the target AP MLD 706. The source AP MLD 704 may send context transfer 720 that includes context e.g. SN, PN etc. related to data for the Non-AP MLD and based on the determination made by the source AP MLD for forwarding data to the target AP MLD e.g. based on a classification (e.g., TID, AC, SCS, etc.) and type information for selecting data at different states within the source AP MLD 704 (e.g., unprocessed MSDU, non-transmitted MPDU, transmitted MPDU, etc.).

The source AP MLD 704 is configured to forward the data (e.g., forwarded data 724 that may be unencrypted or encrypted) identified to the target AP MLD 706 over the DS. In this case, the source AP MLD 704 may take necessary steps to pause transmitting or retransmitting this data, while continuing to transmit the non-forwarded data 726 (e.g., the data not selected for forwarding) to the non-AP MLD 702. For example, the non-forwarded data 726 may not comport with the data classification (e.g., unsupported TID or AC, etc.) and may include rest of the data that was not forwarded to the target AP ML.

Upon reception of the forwarded data 724, the target AP MLD 706 is configured to transmit the forwarded data 724 to the Non-AP MLD over the air. In this case, the target AP MLD 706 may receive the forwarded data 724 as MSDUs, process the MSDUs into MPDUs, and transmit the MPDUs to the non-AP MLD 702. In this case, the non-AP MLD 702 may concurrently receive the forwarded data 724 over-the-air from the target AP MLD and the non-forwarded data 726 from the source AP MLD. In some cases, the forwarded data 724 may be slightly delayed from the target AP MLD 706, but the time delay is minimized based on data forwarding of some data (selective data forwarding) during the roaming.

In one aspect, the roaming response 722 may include various information such as an identifier of the target AP MLD 706, SMDE, starting SN of the data forwarded to the target AP MLD, and a buffered DL data transfer time (or duration) that identifies a window of time duration within which the source AP MLD 704 may transmit the non-forwarded data 726 to the Non-AP MLD 702. In this case, the source AP MLD 704 continues to transmit data for the identified duration to the Non-AP MLD, and thereafter may stop data transmission based on inferring that Non-AP MLD is roamed to the target AP MLD 706 which is continuing data transmission to the Non_AP MLD after roaming completed.

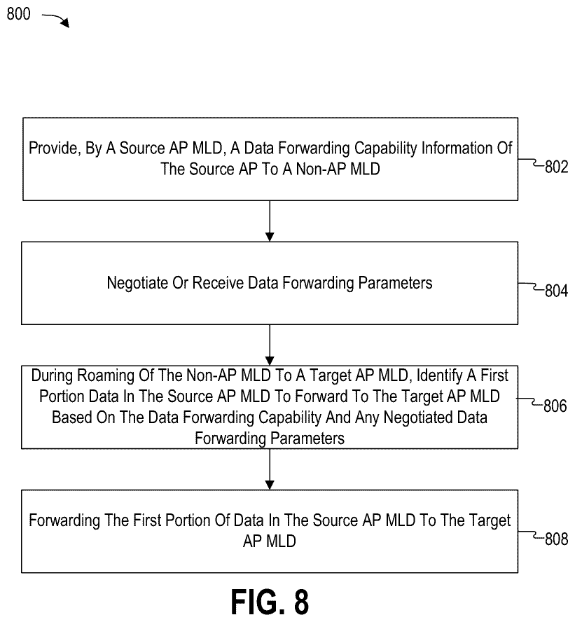

FIG. 8 illustrates an example method 800 of an AP MLD for implementing selective data forwarding based on data forwarding capability information in accordance with some aspects of the disclosure.

At block 802, the AP MLD may provide a data forwarding capability of the source AP MLD to a non-AP MLD device. In some aspects, the data forwarding capability includes at least one of a data support indicator or and data selection indicator. The data forwarding capability is included in at least one of a beacon, probe response, association response, reassociation response, a roaming related frame or a management frame. In one example, the data forwarding support indicator indicates at least one of a selective data forwarding support, no data forwarding support, or AP selected data forwarding. The data selection indicator identifies various classifications of data that can be used to determine whether the traffic is forwarded. For example, the data selection indicator can include a TID indicator for selecting data to forward based on TID, an AC indicator for selecting data to forward based on AC; or an SCS ID indicator for selecting data based on SCS streams. In one example, each of the TID indicator, AC indicator, and SCS ID indicator are a single bit in an 8-bit field. The data support indicator identifies the types of data that can be forwarded. For example, the data support indicator includes an MSDU indicator for forwarding MSDUs and A-MSDUs, an MPDU indicator for forwarding untransmitted MPDUs and A-MPDUs, and a transmitted MPDU indicator for forwarding transmitted MPDUs and A-MPDUs.

At block 804, the source AP MLD may negotiate or receive data forwarding parameters based on the data forwarding capability information with the Non-AP MLD. The negotiating of the data forwarding parameters is performed with the non-AP MLD, and the data forwarding parameters is associated with a roaming request and a roaming response exchanged between the non-AP MLD and the source AP MLD. In one aspect of block 804, when the data forwarding capability information indicates selective data forwarding or all data forwarding, the AP MLD may receive data forwarding parameters and negotiate data selection indicator and data support indicator with the non-AP MLD device. The data forwarding parameters identifies parameters from the data forwarding capability information to implement in the data forwarding processes. The non-AP MLD device may select the suitable data forwarding parameters based on its state, and provide the same to the AP MLD. The AP MLD and the non-AP MLD device may negotiate the data forwarding parameters based on AP policy and resources. In on example, the source AP MLD may solely determine what data to be forwarded to the target AP MLD based on its data forwarding capability information and other policy and factors.

At block 806, the AP MLD may during roaming of the non-AP MLD device to a target AP MLD, identify a first portion of data in the source AP MLD to forward to the target AP MLD based on the data forwarding capability information and any negotiated data forwarding parameters. For example, the AP MLD may search different memories and other storage mechanisms to identify data that could be transmitted, and then filter the data based on the classifications of data to ensure only content identified in the data forwarding parameters (e.g., the first portion of data) is forwarded to the target AP MLD.

In some aspects, the source AP MLD may forward either unencrypted or encrypted data to the target MLD device. The source AP MLD may transmit a sequence number and/or a packet number to the target AP MLD to provide data stream continuity and ensure that the non-AP MLD can deduplicate and correctly order packets when it received forwarded data from the target AP MLD. In another aspect, the AP MLD may transmit a sequence number and/or a packet number to the target AP MLD when the AP MLD supports forwarding previously transmitted MPDUs that have not been acknowledged or non-acknowledged.

At block 808, the AP MLD may forward a first portion of data in the source AP MLD to the target AP MLD during roaming. The source AP MLD may transmit the first portion of data to the target AP MLD while the source AP MLD transmits a second portion of data to the non-AP MLD device (e.g., data that is not forwarded to the target AP MLD and is data other than the data that is filtered based on the data forwarding parameters). In this case, the source AP MLD concurrently forwards the first portion of data to the target AP MLD over the DS while transmitting the second portion of data to the non-AP MLD over the air.

In one aspect, the AP MLD may receive preference for data forwarding parameters from the non-AP MLD, wherein the first portion of data is selected based on data selection indicator. In another aspect, the AP MLD may transmit at least one of a starting sequence number (SN) of the first portion of data forwarded to the target AP MLD, or a last SN of buffered DL data that will be sent by the source AP MLD to the non-AP MLD. In another aspect, the AP MLD may transmit the starting sequence number (SN) of the first portion of data or the last SN of the buffered DL data in a roaming response frame sent to the non-AP MLD.

In another aspect, the source AP MLD provides a buffered DL data transfer time to the non-AP MLD indicating a maximum time for which the second portion of data is available for transmitting to or fetch by the non-AP MLD.

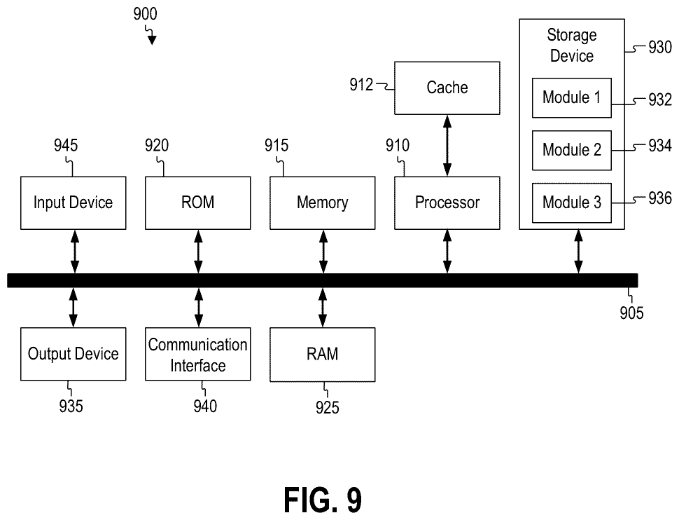

FIG. 9 is a diagram illustrating an example of a system for implementing certain aspects of the present technology. In particular, FIG. 9 illustrates an example of computing system 900, which may be for example any computing device making up internal computing system, a remote computing system, a camera, or any component thereof in which the components of the system are in communication with each other using connection 905. Connection 905 may be a physical connection using a bus, or a direct connection into processor 910, such as in a chipset architecture. Connection 905 may also be a virtual connection, networked connection, or logical connection.

In some embodiments, computing system 900 is a distributed system in which the functions described in this disclosure may be distributed within a datacenter, multiple data centers, a peer network, etc. In some embodiments, one or more of the described system components represents many such components each performing some or all of the function for which the component is described. In some embodiments, the components may be physical or virtual devices.

Example system 900 includes at least one processing unit (CPU or processor) 910 and connection 905 that communicatively couples various system components including system memory 915, such as ROM 920 and RAM 925 to processor 910. Computing system 900 may include a cache 912 of high-speed memory connected directly with, in close proximity to, or integrated as part of processor 910.

Processor 910 may include any general purpose processor and a hardware service or software service, such as services 932, 934, and 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 includes an input device 945, which may represent any number of input mechanisms, such as a microphone for speech, a touch-sensitive screen for gesture or graphical input, keyboard, mouse, motion input, speech, etc. Computing system 900 may also include output device 935, which may be one or more of a number of output mechanisms. In some instances, multimodal systems may enable a user to provide multiple types of input/output to communicate with computing system 900.

Computing system 900 may include communications interface 940, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, WLAN signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, RAM, static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 930 may include software services, servers, services, etc., that when the code that defines such software is executed by the processor 910, it causes the system to perform a function. In some embodiments, a hardware service that performs a particular function may include the software component stored in a computer-readable medium in connection with the necessary hardware components, such as processor 910, connection 905, output device 935, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the embodiments and examples provided herein, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual embodiments may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some embodiments the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (<) and greater than (>) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

What is claimed is:

1. A method, comprising:
providing, by a source access point (AP) multi-link device (MLD), a data forwarding capability of the source AP MLD to a non-AP MLD;
during roaming of the non-AP MLD to a target AP MLD, identifying a first portion data in the source AP MLD to forward to the target AP MLD based on the data forwarding capability, wherein the target AP MLD and the source AP MLD are configured in a seamless mobility domain; and
forwarding a first portion of data in the source AP MLD to the target AP MLD during roaming.

2. The method of claim 1, wherein the data forwarding capability includes at least one of:
a data forwarding support indicator indicating types of data forwarding supported by the source AP MLD; or
a data forwarding policy identifying different types of data that can be forwarded by the source AP MLD.

3. The method of claim 2, wherein the data forwarding support indicator indicates at least one of a selective data forwarding support, no data forwarding support, all data forwarding support or AP selected data forwarding support.

4. The method of claim 2, wherein the data forwarding policy includes at least one of a data selection indicator, a data support indicator, or an explicit indicator of whether negotiation for data forwarding parameters is supported with the non-AP MLD.

5. The method of claim 4, wherein the data selection indicator comprises at least one of:
a traffic identifier (TID) indicator for selecting data to forward based on TID;
an access category (AC) indicator for selecting data to forward based on AC; or
a stream classification service identifier (SCS ID) indicator for selecting data to forward based on SCS ID.

6. The method of claim 4, wherein the data support indicator includes at least one of:
a media access control (MAC) service data unit (MSDU) indicator for forwarding MSDUs or A-MSDUs;
a MAC protocol data unit (MPDU) indicator for forwarding MPDUs that are not transmitted by the source AP MLD; or
a transmitted MPDU indicator for forwarding MPDUs that have been transmitted by the source AP MLD to the non-AP MLD.

7. The method of claim 6, wherein the negotiation of the data forwarding parameters is associated with a roaming request and a roaming response exchanged between the non-AP MLD and the source AP MLD.

8. The method of claim 1, wherein the data forwarding capability is included in at least one of a beacon, probe response, association response, reassociation response, a roaming related frame or a management frame.

9. The method of claim 1, further comprising:
negotiating data forwarding parameters with the non-AP MLD, wherein the first portion of data is selected based on at least one of data selection indicator or data support indicator negotiated with the non-AP MLD.

10. The method of claim 1, further comprising:
receiving preference for data forwarding parameters from the non-AP MLD, wherein the first portion of data is selected based on data selection indicator.

11. The method of claim 1, further comprising transmitting, by the source AP MLD to the non-AP MLD, at least one of a starting sequence number (SN) of the first portion of data forwarded to the target AP MLD, or a last SN of buffered DL data that will be sent by the source AP MLD to the non-AP MLD.

12. The method of claim 1, further comprising transmitting a starting sequence number (SN) of the first portion of data or a last SN of buffered DL data in a roaming response frame sent to the non-AP MLD.

13. The method of claim 1, further comprising providing the data forwarding capability for the source AP MLD or for the seamless mobility domain (SMD).

14. The method of claim 1, wherein the source AP MLD transmits a second portion of data to the non-AP MLD device concurrently with forwarding the first portion of data to the target AP MLD.

15. The method of claim 1, wherein the source AP MLD provides a buffered DL data transfer time to the non-AP MLD indicating a maximum time for which a second portion of data is available for transmitting to or fetch by the non-AP MLD.

16. An access point multi-link device (AP MLD), comprising:
at least one memory; and
at least one processor coupled to the at least one memory and configured to:
provide a data forwarding capability of the AP MLD to a non-AP MLD;
during roaming of the non-AP MLD to a target AP MLD, identifying a first portion data in the AP MLD to forward to the target AP MLD based on the data forwarding capability, wherein the target AP MLD and the AP MLD are configured in a seamless mobility domain, the AP MLD being a source AP MLD of the non-AP MLD; and
forwarding a first portion of data in the AP MLD to the target AP MLD during roaming.

17. The AP MLD of claim 16, wherein the data forwarding capability includes at least one of:
a data forwarding support indicator indicating types of data forwarding supported by the source AP MLD; or
a data forwarding policy identifying different types of data that can be forwarded by the source AP MLD.

18. The AP MLD of claim 17, wherein the data forwarding support indicator indicates at least one of a selective data forwarding support, no data forwarding support, or AP selected data forwarding.

19. The AP MLD of claim 17, wherein the data forwarding policy includes at least one of a data flow selection indicator, a data forwarding type indicator, or an explicit indicator of whether negotiation for data forwarding parameters is supported with the non-AP MLD.

20. The AP MLD of claim 19, the data flow selection indicator comprises at least one of:
a traffic identifier (TID) indicator for selecting data to forward based on TID;
an access category (AC) indicator for selecting data to forward based on AC; or
a stream classifier service identifier (SCS ID) indicator for selecting data to forward based on SCS ID.
